(19) United States
(12) Patent Application Publication
(10) Pub. No.: US 2019/0082669 A1
(43) Pub. Date: Mar. 21, 2019

(54) Fishing Weight Design with Crushing Action

(71) Applicant: Richard August Kramer, Peru, IL (US)

(72) Inventor: Richard August Kramer, Peru, IL (US)

(21) Appl. No.: 16/115,403

(22) Filed: Aug. 28, 2018

Related U.S. Application Data
(60) Provisional application No. 62/559,160, filed on Sep. 15, 2017.

(51) Int. Cl. A01K 95/02; A01K 95/00

(52) U.S. Cl. CPC A01K 95/02; A01K 95/005

(57) ABSTRACT

A crushable fishing weight can include a body fashioned from malleable metal having a plurality of channels. In at least some embodiments, the body is cylindrical and the channels run parallel to the longest axis of the cylindrical body. In some embodiments, a hanger apparatus with a hanger eye occupies one of the channels. A lure assembly can be affixed to the hanger, and incoming line to which the lure is to be attached is fed through the plurality of channels. When the weight is crushed, the friction from the channels against the line holds the line in place, thus affixing a weight and lure system to the incoming line without additional knots.

### CROSS-REFERENCE TO RELATED APPLICATION

This application claims priority benefits from U.S. provisional patent application Ser. No. 62/559,160 filed on Sep. 15, 2017, entitled “Fishing Weight Design With Crushing Action”. The '160 application is hereby incorporated by reference herein in its entirety.

### FIELD OF THE INVENTION

The present invention relates to fishing tackle, and in particular tackle used to weight a fishing line.

Humans have fished for centuries. Methods of catching fish have advanced and diversified over time, from simply using one's hands to pluck a fish from the water, to the methods of trawling, seining, and angling employed by modern day commercial and sport fishermen. While high volume commercial mechanisms of fishing (such as trawling and seining) are designed to maximize harvest in a minimum amount of time, angling with a rod remains a popular pastime, and is still the most prudent way of landing many varieties of fish. Images dating as far back as 2000 B.C.E. show fishermen practicing basic rod and line fishing, and archaeological digs have uncovered simple gorge hooks made from bone and other materials dating back thousands of years.

Despite a plurality of angling methods emerging between the fifteenth and twentieth centuries, an angler's prime objective has remained constant; trick a fish into biting a hook. The answers to three basic questions dictate the appropriate angling methods: where are the fish, where do the fish expect food to be, and what type of food are the fish expecting? A successful angler selects fishing tackle based on the answers to these questions. Two main camps of angling have emerged, fly fishing and spin fishing. Even though both basic methods involve using a hook, rod, and line to catch a fish, equipment for each is heavily specialized. Fly fishing entails using a noticeable, lightweight projectile (“fly”) to skim the surface of the water, attempting to entice a fish to breach and attack the fly in which a hook is buried. Spin fishing involves placing a lure beneath the water's surface, and enticing a fish to bite on that lure. Spin fishing lures can have multiple components, one of which can be a weight or plurality of weights called sinker(s) or knoch(s). While knoch(s) can be employed in fly fishing to assist in weighting a fly to perform the whipping action characteristic of fly fishing, they are most often seen in spin fishing setups.

Fishing weights can provide a variety of benefits to an angler depending on their design. Notable results of adding weights include having a lure which sinks more quickly, the ability to anchor a lure setup at a desired depth in the water, and the ability to cast a weighted lure further than an unweighted one. Common weights used in spin fishing fit generally into three categories; split-shot weights, in-line weights, and drop shot weights. Split shot weights have an open slit which can sandwich a length of fishing line. These weights are then crushed to adhere to a particular location on the line. The main advantage of split-shot weights is that they do not require knots to be untied or line to be severed to weight a line. The remaining two broad categories, in-line and drop shot weights, require that an untethered end of line (called the “terminal end”) be threaded through some part of the weight. In-line weights feature a channel passing through the weight, and the terminal end of the line is fed through this channel. Drop shot weights have a loop or hole at one extrema of the weight through which the line is threaded, and they are designed to hang beneath a hook and bait on a line in the water.

While there are many sub-categories of the above basic designs which can provide benefits to anglers for various underwater environments, weights are often characterized broadly by how they interact with a lure assembly and/or the terminal end of a fishing line. Accordingly, weights which interact with a line and/or a lure to reduce the work required by an angler to assemble the lure and/or line would be advantageous.

### SUMMARY OF THE INVENTION

Shortcomings of conventional fishing weights are overcome by a weight assembly comprising a body having a plurality of channels. The body can be composed of a malleable material which can be crushed with pliers.

One of the channels within the body can house an eyehook or comparable hanging apparatus, to which a lure assembly can be affixed. In many embodiments, a lure assembly can be tied to the hanging apparatus.

The channels can be coated with rubber and have rounded or chamfered edges to minimize, or at least reduce, the risk of cutting fishing line when the weight can be crushed.

When the weight can be crushed, the channels can collapse around fishing line threaded through them, and thus affix the weight and potential attachments to a line without the need for knots.

It some embodiments the fishing weight includes a body, at least one channel; and a hanger. In some embodiments, the body can be cylindrical. In some embodiments, the hanger can be an eyehook. In at least some embodiments, the body can be configured to be crushed.

In at least some embodiments, at least one channel can be configured to accept a fishing line. In some embodiments, the body contains two channels. In some embodiments, the body contains three channels. In some embodiments, the body contains four channels. In some embodiments, a channel houses a hanger. In at least some embodiments, at least one channel terminates in a rounded edge. In at least some embodiments, at least one channel terminates in a chamfered edge. In some embodiments, at least one channel can be lined with rubber. In at least some embodiments, at least one channel runs parallel to the longest axis of the cylindrical body. In some embodiments, multiple channels run parallel to each other. In at least some embodiments, at least one channel houses an eyehook.

In at least some embodiments, the body comprises a split. In some embodiments, the body can be fashioned from lead. In some embodiments, the fishing weight contains a magnetic strip. In some embodiments, the weight can be painted in a fluorescent color. In some embodiments, the weight can be scented.

In some embodiments, a fishing crush-weight assembly includes a crush weight with a first channel running parallel to a first axis, wherein the crush weight can be configured to be crushed around a fishing line inserted into the first channel; a hanger comprising an eyehook; a lure line attached to the hanger at a first end of the lure line; and a hook attached to the line at a second end of the lure line. In some embodiments, the crush-weight body can be cylindrical. In some embodiments, the crush weight can be made of a magnetic metal. In some embodiments, the crush weight can include a second channel, wherein the second channel runs parallel to the first axis and can be configured to accept the fishing line.

In some embodiments, the fishing crush-weight assembly can be manufactured as a single unit. In some embodiments, the fishing crush-weight assembly can be configured to be disposable.

### BRIEF DESCRIPTION OF THE DRAWINGS

FIG. 1A is a front perspective view of a crush weight assembly affixed to a terminal end of a lure assembly.

FIG. 1B is a front perspective view of a crush weight assembly with an embedded hanger.

FIG. 2A is a side view of a crush weight assembly affixed to a terminal end of a lure assembly.

FIG. 2B is a side view of a crush weight assembly with an embedded hanger.

FIG. 3 is a side view of a hanger eye.

FIG. 4 is a side perspective view of a crush weight body.

FIGS. 5A and 5B are top views of a crush weight body.

FIG. 6 is a side perspective view of a crush weight assembly affixed to a terminal end of a lure assembly and a terminal end of an incoming fishing line.

FIG. 7 is a side view of a hook.

FIG. 8 is a sectional view of a crush weight body, taken in the direction of the arrows affixed to line VIII in FIG. 5A.

FIG. 9 is a transparent perspective view of a crush weight assembly showing a path for a terminal end of an incoming line through channels in the crush weight body.

FIG. 10 is a cutaway side view of a crush weight assembly with channels and a hanger eye assembly shown.

FIG. 11 is a cutaway perspective view of a crush weight assembly affixed to a terminal end of a lure assembly and a terminal end of an incoming fishing line, wherein the path of an incoming fishing line is shown.

FIG. 12 is a side perspective view of a crush weight assembly having a split feature.

FIG. 13 is a side perspective view of a crush weight assembly having three channels.

FIGS. 14A-14L show a plurality of possible configurations of a body of a crush weight.

FIG. 15 is a cutaway perspective side view of a crush weight assembly having four channels.

FIG. 16 is a cutaway perspective side view of a crush weight assembly having a magnetic strip.

### DETAILED DESCRIPTION OF ILLUSTRATIVE EMBODIMENT(S)

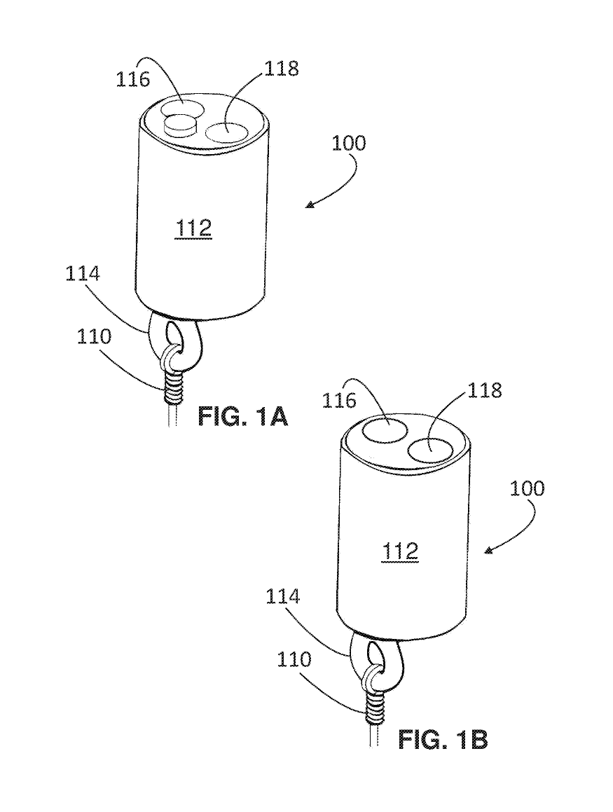

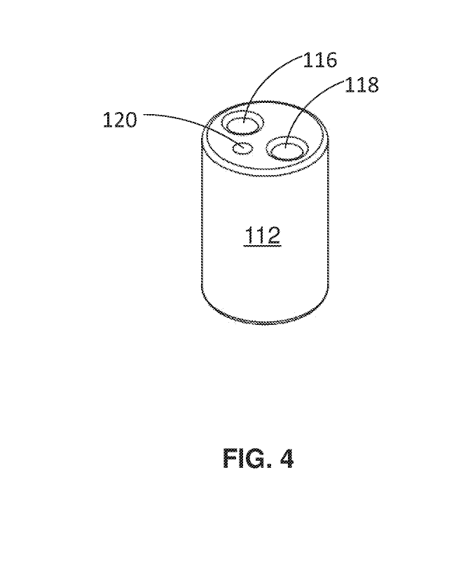

Turning first to FIG. 1A, an illustrative embodiment of crush weight assembly 100 is shown. Crush weight assembly includes body 112. In at least some embodiments, such as that shown in FIG. 1A, body 112 comprises at least two channels 116 and 118. In some embodiments, body 112 comprises one channel. In other embodiments, body 112 can comprise more than two channels. Body 112 is illustrated in greater detail by FIG. 4, showing channels 116 and 118 and channel 120, through which hanger eye 114 in FIG. 1A can be positioned.

In some embodiments, body 112 contains hanger eye 114. In at least some embodiments, terminal end 110 of a lure assembly (not pictured) can be affixed to hanger eye 114.

In some embodiments, hanger eye 114 can be embedded or encapsulated in body 112 such that hanger eye 114 does not project from the top of body 112, as shown in FIG. 1B.

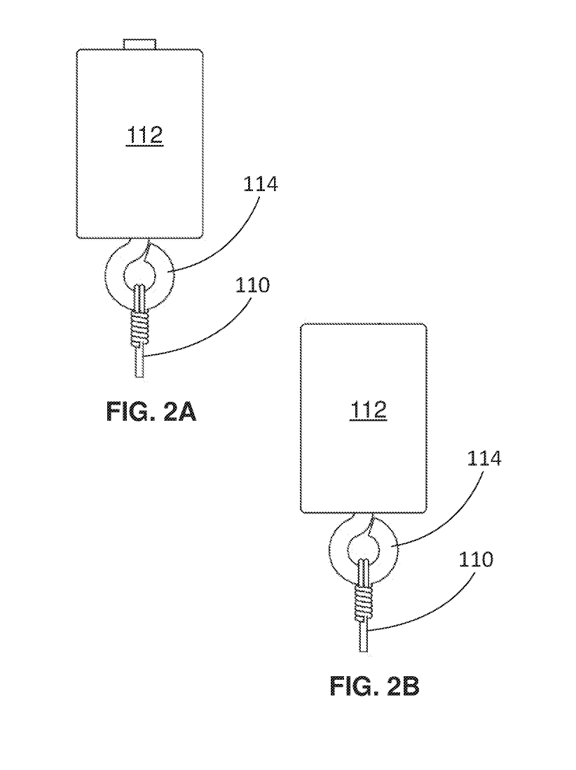

FIG. 2A illustrates a side view of the crush weight assembly 100 shown in FIG. 1A. FIG. 2B illustrates a side view of the crush weight assembly 100 shown in FIG. 1B.

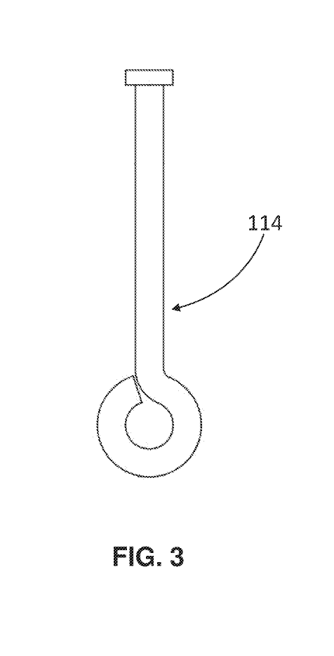

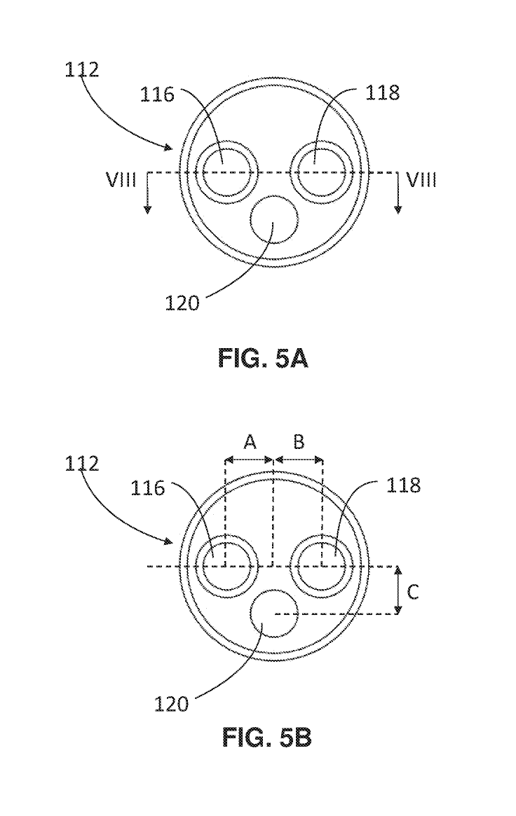

FIG. 3 shows hanger eye 114 to be received by channel 120. Top views of body 112 are provided by FIGS. 5A and 5B.

A crush weight allows an angler to quickly affix terminal fishing tackle, such as a lure assembly, to the terminal end of an incoming fishing line. In some embodiments, the incoming fishing line can be part of a rod and reel system for spin fishing. In the embodiment illustrated by FIGS. 1-5, an incoming fishing line can be received by one of two channels 116 and 118. That incoming line can be then fed back through the other channel. In some embodiments, the crush weight can be constructed from a pliable metal, such that a user can apply pressure to the crush weight with a set of pliers or similar tool and crush body 112. When body 112 is crushed, channels 116 and 118 can collapse around the incoming line, holding the line in place and affixing the crush weight to the incoming line.

In some embodiments, distance A and/or B, illustrated in FIG. 5B, can be 0.063 inches (1.60 mm). In some embodiments, distance C can be 0.063 inches (1.60 mm). In some embodiments, distance A, B, and/or C can have a tolerance of ±0.005 inches (0.127 mm).

In some embodiments, the circumference of body 112 can be 0.25 inches (6.35 mm). In some embodiments, the circumference of body 112 can have a tolerance of ±0.010 inches (0.254 mm). In some embodiments, the circumference of channel 116 and/or channel 118 can be 0.076 inches (1.93 mm). In some embodiments, the circumference of channel 116 and/or channel 118 can have a tolerance of ±0.005 inches (0.127 mm). In certain embodiments, the circumference of channel 116 can be the same as the circumference of channel 118. In at least some embodiments, the circumferences of channel 116 and channel 118 can be different.

In some embodiments, the circumference of channel 116 and/or 118 can be 0.0625 inches (1.59 mm).

In some embodiments, the circumference of receiving channel 120 can be 0.038 inches (0.965 mm). In some embodiments, the circumference of receiving channel 120 can have a tolerance of ±0.005 inches (0.127 mm).

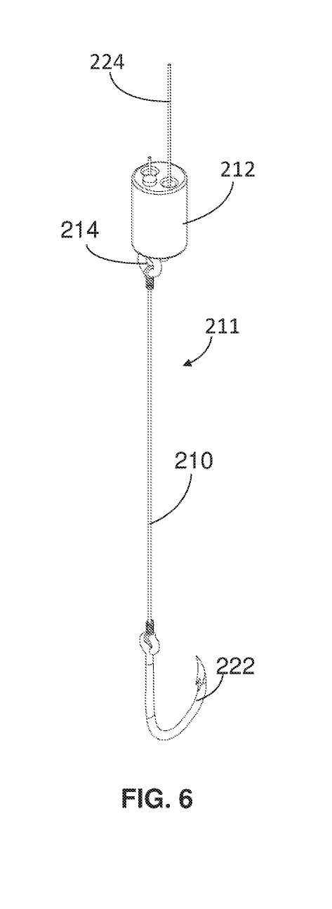

In some embodiments, such as the embodiment shown in FIG. 6, a crush weight assembly can include body 212 and hanger eye 214. Hanger eye 214 is shown in use with the terminal ends of both incoming line 224 and lure assembly 211. In some embodiments, such as the one illustrated in FIG. 6, lure assembly 211 can consist of terminal line end 210 and hook 222.

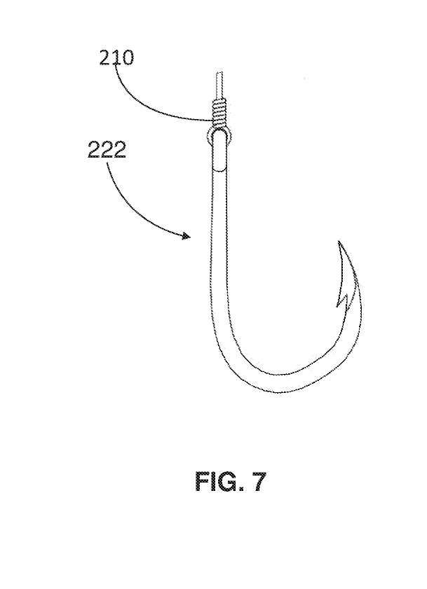

As shown by FIGS. 6 and 7, in at least some embodiments, a crush weight assembly can allow a fisherman to create a lure assembly, which can be affixed to the crush weight. In at least some embodiments, the lure assembly can be attached to the crush weight using a knot, tying hanger eye 214 (and comparable attachment points in other embodiments) to the terminal end of the lure line 210. Using this system, a fisherman can create a pre-assembled lure with pre-determined properties. Once that lure has been attached to the crush weight, the fisherman can then attach the crush weight to the incoming line without having to tie additional knots.

By using pre-assembled lures, a fisherman can more easily adhere to established standards for lures in sport, industrial applications, or recreational fishing. Properties such as the length of a line, presence of in-line weights, types of bait, and structure of hooks can be determined before embarking. This allows a fisherman to quickly change out one lure assembly for another on the fly and allows for industrial applications to better standardize lure packages which can be swapped. In at least some embodiments, proper application of pressure with pliers and similar tools allows a fisherman to remove the crush weight and corresponding lure assembly from the incoming line without having to cut the incoming line.

In some embodiments, the crush weight assembly can function as a weight that can be placed before the lure on a fishing line. Some such embodiments can be useful for applications where a fisherman intends to use a float or bobber, as the weight serves to anchor the lure's position in the water. In certain applications, such as but not limited to spin fishing, a weight can allow a fisherman to cast further, and/or can keep a lure and/or float assembly from being carried away by a current. In some embodiments, the crush weight assembly can make spin fishing in rivers and other freshwater and/or marine waters more feasible.

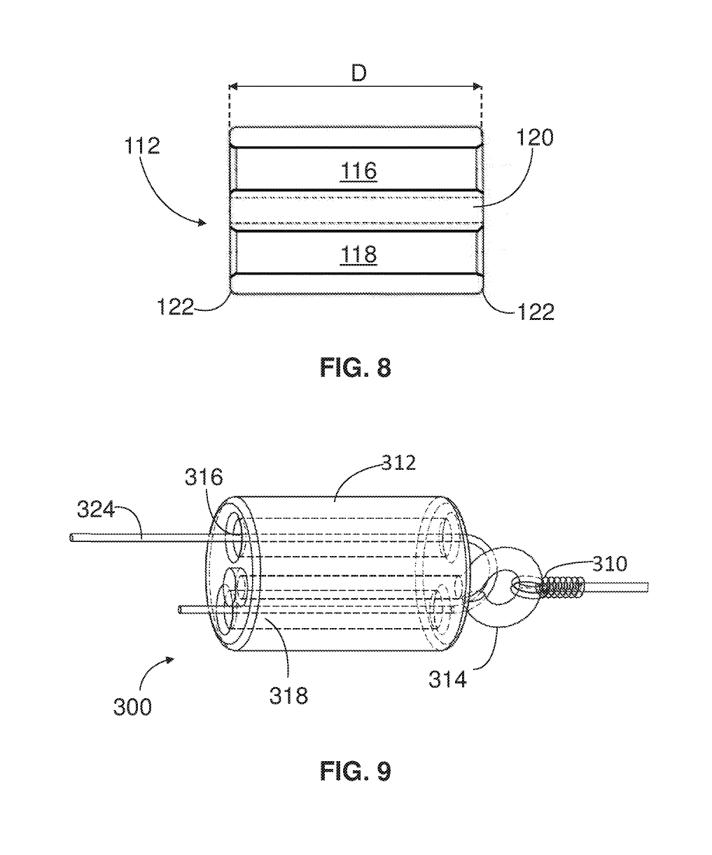

FIG. 8 illustrates weight body 112 according to some embodiments, in a section view taken in the direction of the arrows shown on line VIII on FIG. 4. Receiving channel 120 for hanger eye 114 is shown in dashed lines.

In some embodiments, distance D, illustrated in FIG. 8, can be 0.375 inches (9.53 mm). In some embodiments, distance D can have a tolerance of ±0.010 inches (0.254 mm).

In some embodiments, weight body 112 can have rounded ends 122. In at least some embodiments, ends 122 can have a radius of curvature of 0.010 inches (0.254 mm). In some embodiments, the radius of curvature of ends 122 can have a tolerance of ±0.005 inches (0.127 mm).

FIG. 9 shows crush weight assembly 300 wherein weight body 312 receives incoming terminal line 324 through channels 316 and 318. Hanger 314 can be affixed to terminal end 310 of a lure assembly (not pictured).

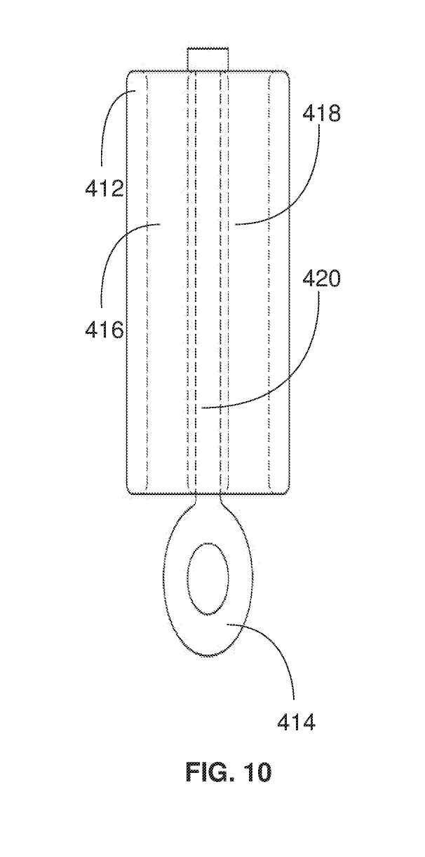

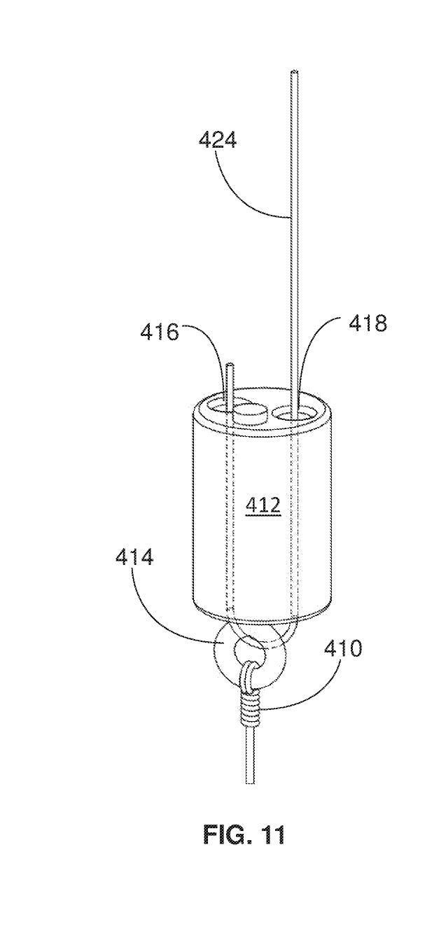

FIG. 10 shows an embodiment of a crush weight assembly wherein hanger 414 can be in a closed-loop configuration. Hanger 414 can be anchored to body 412 through channel 420. As FIG. 11 shows, this embodiment allows for incoming terminal line 424 to be fed through channel 418, the closed eye of hanger 414, and back out through channel 416. Eye 414 can further anchor a terminal end 410 of a lure assembly (not pictured).

In some embodiments, such as that shown in FIG. 10 closed loop hanger 414 can accept an incoming line without risking damage to that line from sharp edges. Additionally, in at least some embodiments, a closed loop hanger does not allow for a lure assembly to slip off the hanger. In some embodiments, a hanger component of the crush weight assembly further comprises a swivel, such as a ball joint. In such embodiments, the swivel allows for a lure assembly to move more freely in the water without putting additional stress on the attachment point of the lure assembly. Since the weakest point in a lure assembly is often where the knots are tied, reducing stress at such points decreases the chance of a fish being able to break a line.

A lure assembly need not be affixed to a hanger by a knot; rather, many clips, linking assemblies, and the like, can be affixed to the hanger instead, with a lure tied to such components. In at least some embodiments, a linking assembly can comprise a ball joined double clip.

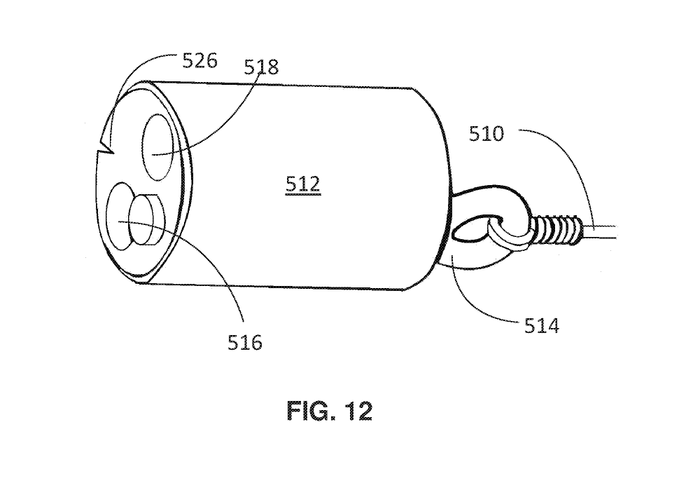

In some embodiments, such as that shown in FIG. 12, crush weight body 512 can comprise at least one split 526, channel 516, and/or channel 518. In at least some embodiments, hanger 514 can be affixed to the body to receive terminal end 510 of a lure assembly (not pictured).

In embodiments having at least one split 526, a fisherman can use the crush weight in place of a split-shot weight when desired. In some embodiments, a lure can be affixed to the crush weight assembly using the split, which can be crushed around the line to hold it in place.

FIG. 13 shows body 612 having channels 616, 618, and 628. In this embodiment, hanger 614 can be present and affixed to terminal end 610 of a lure assembly (not pictured).

The number of channels given on the embodiments described herein should not be considered a limitation on the configuration of the present crush weight, as various numbers of channels capable of receiving lines can be used.

In some embodiments, channels for receiving lines are coated or sleeved with rubber. In such embodiments, the rubber coating/sleeving can help to increase friction between the incoming line and the crush weight, which better helps to hold the line in place, and/or can provide a padded layer to keep a line from being weakened or severed when the weight is crushed.

In some embodiments, channels are terminated through a chamfered or rounded edge. Chamfered and rounded edges decrease the possibility that lines will be severed by catching on an edge of one of said channels.

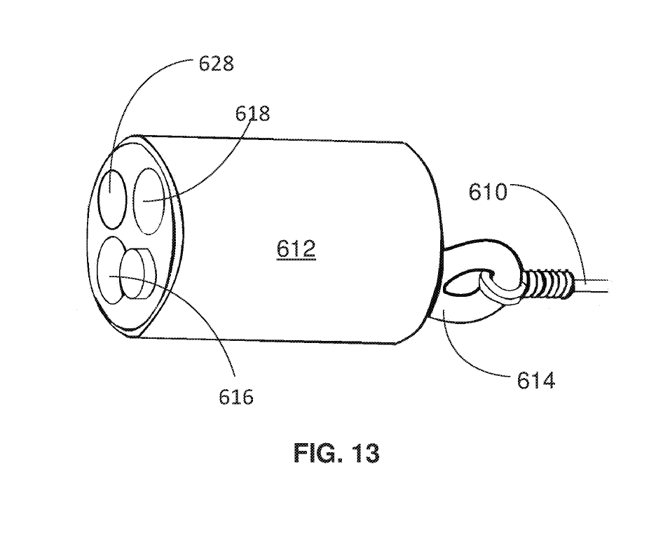

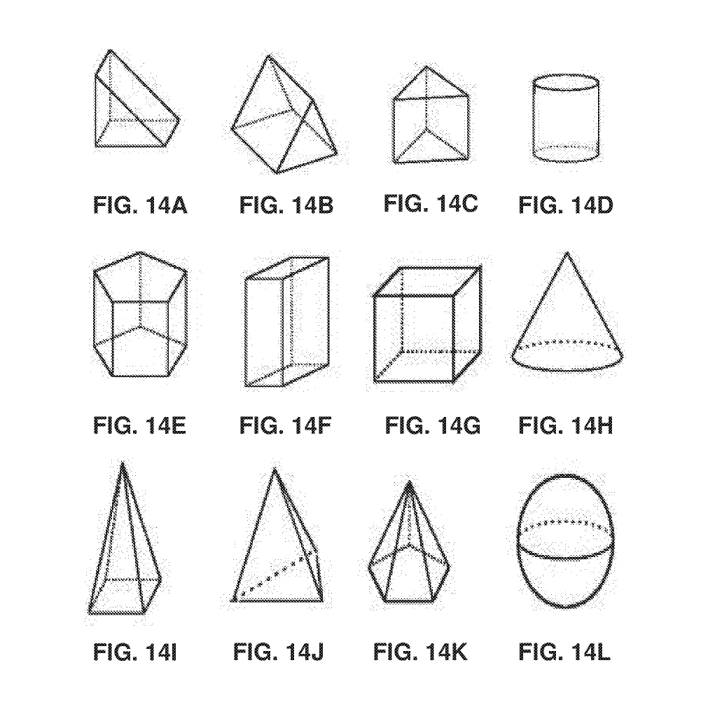

FIGS. 14A-L show a plurality of possible shapes for the body of a crush weight assembly. The shape of the body of a crush weight can be varied to suit the conditions of a fishing environment. For instance, weights having rounded surfaces, such as in FIG. 14D and FIG. 14L, can be advantageous when an angler seeks to avoid snagging a lure on rocks; this can be advantageous for fishermen fishing in rocky riverbeds. In some instances, weights with bodies shaped as in FIGS. 14 I-K can help to anchor a lure to a sandy riverbed, bringing tackle to a depth where fish are more likely to bite.

FIGS. 14A-C show various triangular prism constructions for a weight body, which, at least in some embodiments, can be crushed by individual vertices more precisely than applications having rounded edges. Crush weights can also other shapes not pictured, such as a bullet for Texas worm fishing applications. The particular shape of a body should not be considered a limitation on the configuration of the present crush weight, as crush weights can be shaped to suit a particular set of water conditions, or type of attached lure.

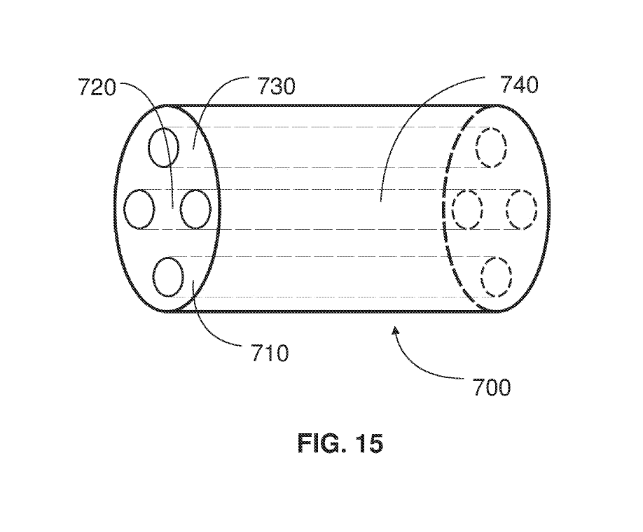

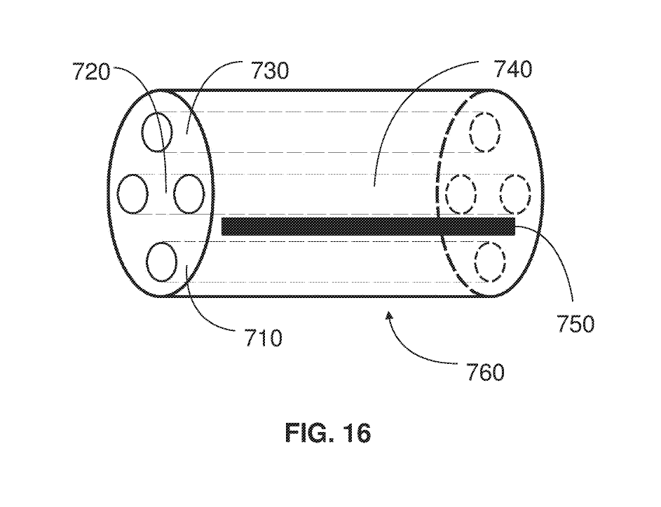

FIG. 15 illustrates an embodiment of crush weight 700 having four channels 710, 720, 730, and 740. In some embodiments, the crushing action of the crush weight can hold both the terminal end of the incoming line and the terminal end of a lure assembly without the use of knots. Such embodiments can be particularly useful for beginners, who can struggle with tying the various knots experienced anglers are accustomed to. By threading the terminal end of the incoming line through 720 and out through 740, and the terminal end of the lure assembly line in through 730 and out through 710 in the opposite direction, both lines can be held without tying a single knot.

FIG. 16 shows an embodiment of crush weight 760 comprising magnetic strip 750. Magnetic strip 750 can be used to assist in storage of weights, allowing a fisherman to store crush weights along a magnetic strip affixed to his gear, or the inside of a conventional tackle box.

Pliable metals from which the crush weight can be manufactured include lead, brass, tin, steel, and in some cases tungsten. In some embodiments, a crush weight can be scented.

In some embodiments, the crush weight assembly, or portions thereof, can be heat treated and/or plated.

In some embodiments, a crush weight can be painted. In some of these embodiments, fluorescent colors are chosen to attract fish. Depending on the desired painting or scenting, different metals can be chosen for manufacture. For instance, steel can be chosen for scented applications due to its porosity.

While lead is a common material for weight manufacture due to its high density and malleability, many jurisdictions have banned lead weights in certain mass ranges, and some have banned their use entirely. Substitutes for lead weights can include brass (which is less dense but is reflective and thus attractive to some fish) and tin (which is malleable and less expensive, but also considerably less dense). The metal of manufacture should not be considered a limitation on the configuration of the present crush weight. Additionally, the crush weight can be manufactured from various malleable and high-density plastic and composite materials.

In some embodiments, the length of the weight body can measure up to and inclusive of 6 inches (15.2 cm).

In some embodiments, the diameter of the weight body can measure up to and inclusive of 1 inch (2.54 cm).

In some embodiments, the weight of the weight body can measure up to and inclusive of 5 lbs.

The weight body in any of the illustrative embodiments, or any derivation thereof, can be scaled to a variety of dimensions and/or can be made from a variety of suitable materials depending on the type of fishing such as, but not limited to, freshwater fishing, saltwater fishing, ice fishing, spin fishing, shore fishing, shallow water fishing, offshore or boat fishing, deep sea fishing, bottom fishing, reef fishing, wreck fishing, big game fishing, and/or rock fishing.

Various embodiments of the weight body can be used with a variety of fishing lines including, but not limited to, monofilament, braided, steel, nylon, fluorocarbon, titanium and/or wire.

Various embodiments of the weight body can be used with a variety of fishing hooks including, but not limited to, O'Shaughnessy, Kirby, Aberdeen, limerick, Carlisle, cam-action, sneak, sproat, beak point, bait, circle, siwash, worm, jig, wide gap, bent down, pike, hump shank, central draught, tone circle, weedless, double, barbless, baitholder, and/or treble.

While elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A fishing weight comprising:
(a) a body;
(b) a plurality of enclosed channels extending through said body; and
(c) a hanger housed within one of said plurality of channels.

2. The weight of claim 1, wherein said body is cylindrical.

3. The weight of claim 1, wherein said plurality of channels comprises two channels configured to be crushed around a fishing line threaded through said two channels.

4. The weight of claim 3, wherein said two channels terminate in rounded edges.

5. The weight of claim 3, wherein said two channels are lined with rubber.

6. The weight of claim 4, wherein said body is constructed from lead.

7. The weight of claim 3, wherein said two channels terminate in chamfered edges.

8. A fishing weight comprising:
(a) a cylindrical body having a plurality of channels running parallel to the longest axis of said cylindrical body; and
(b) a hanger comprising an eyehook.

9. The weight of claim 8, wherein said cylindrical body further comprises a split.

10. The weight of claim 8, wherein said plurality of channels comprises four channels, and one of said channels is used to house said eyehook.

11. The weight of claim 8, wherein said channels are lined with rubber.

12. The weight of claim 8, wherein said channels have chamfered edges.

13. The weight of claim 9, wherein said cylindrical body is constructed from lead.

14. A fishing weight comprising:
(a) a body having a plurality of channels; and
(b) a magnetic strip.

15. The weight of claim 14, wherein said plurality of channels comprises four channels, and wherein said body is cylindrical, and wherein said channels run parallel to the longest axis of said cylindrical body.

16. The weight of claim 14, wherein said weight is painted in a fluorescent color.

17. The weight of claim 14, wherein said weight is scented.

18. A fishing crush weight assembly comprising:
(a) a cylindrical body comprising:
(i) a first channel running parallel to a first axis, wherein said cylindrical body is configured to be crushed around a fishing line inserted into said first channel;
(b) a hanger comprising an eyehook;
(c) a lure line attached to said hanger at a first end of said lure line; and
(d) a hook attached to said lure line at a second end of said lure line.

19. The fishing crush weight assembly of claim 18 wherein said cylindrical body is made of magnetic metal.

20. The fishing crush weight assembly of claim 18 wherein said cylindrical body further comprises:
(ii) a second channel, wherein said second channel runs parallel to said first axis and is configured to accept said fishing line.
